(19) United States
(12) Patent Application Publication
(10) Pub. No.: US 2002/0067361 A1
(43) Pub. Date: Jun. 6, 2002

(54) Screen raster generation via programmable lookup tables

(76) Inventors: Jens Rennert, Santa Clara, CA (US); Ralph Escherich, Sunnyvale, CA (US)

Correspondence Address: Corporate Patent Counsel, U. S. Philips Corporation, 580 White Plains Road, Tarrytown, NY, 10591, US

(21) Appl. No.: 09/728,806

(22) Filed: Dec. 2, 2000

(51) Int. Cl. G09G 5/36; G06T 11/20

(52) U.S. Cl. 345/441

(57) ABSTRACT

A raster generator sequences through a list of line descriptors to produce a screen raster. The line descriptors include a line-count parameter and a line-type parameter. The line-type parameter defines the characteristics of each type of raster line, and the line-count parameter defines the number of lines of this type occurring in the sequence of lines that define the entire video or image frame. For efficient encoding, the characteristics of each type of raster line is defined in terms of a list of raster pattern types, each raster pattern type being further defined in terms of a sequence of specified durations of particular raster values. The raster generator sequences through the lists of line descriptors, raster patterns, and duration-value pairs, in a nested fashion, thereby generating the screen raster pattern as a sequence of individual raster values that occur for specified durations within each line of each frame. In a preferred embodiment, the raster generator includes a programmable memory for containing each of the parameters that define raster.

### BACKGROUND OF THE INVENTION

1. Field of the Invention

This invention relates to the field of video processing, and in particular to a system for generating screen raster signals, based on parameters contained in a programmable lookup table.

2. Description of Related Art

As competing technologies are developed for video displays, and in particular television displays, differing standards have been promulgated. For example, conventional televisions in the United States conform to the ‘NTSC’ standard, while televisions in other countries may conform to the ‘SECAM’ or ‘PAL’ standards. As the high-definition television (HDTV) technologies have been developed, a number of standards have also been developed. Often, the technologies and standards are constrained by requirements of backward-compatibility with prior standards, bandwidth limitations, current technical feasibility, and so on. As the constraints are relaxed or removed, new standards will continue to evolve.

One of the substantial aspects of television standards is the definition of the “raster”, the sequence of scan lines that form the image, including ancillary information that may be embedded in the non-visible portions of the totality of scan lines that form each image frame. FIGS. 1 and 2 illustrate example components of the definition of a raster. FIG. 1A illustrates an example timing diagram of the major timing events within a raster line, corresponding substantially to the SMPTE 240M standard, and the BT.709 1125/60 standard. FIG. 1B illustrates the same timing events within a raster line corresponding substantially to the BT.709 1125/50, and the ITU-R BT.1120 1250/50 standard. Each of these timing diagrams illustrates the flanking of a video portion 120 by a set of synchronization signals 110, 130. A display device uses these synchronization signals to maintain the proper correspondence between the beginning of each transmitted video line and the start of each displayed video line (horizontal synchronization). Because the relative timing of events differs between standards, as illustrated in FIGS. 1A and 1B, scan lines that are encoded using one standard will not be properly displayed by a device that is configured to conform to another standard.

In like manner, a series of synchronization sequences are also provided before and after each transmitted video frame, to maintain the proper correspondence between the beginning of each frame and the top of each displayed image frame (vertical synchronization). The sequences forming the vertical synchronization contain other specific timing events within the raster line, not illustrated in FIG. 1, to distinguish these sequences from the active video portions of each frame, and to provide signaling that is useful for dynamic threshold control and other enhancements. As with the horizontal synchronization, frames that are encoded using one standard for vertical synchronization will not be properly displayed by a device that is configured to conform to another standard.

FIGS. 2A and 2B demonstrate differences between standards at the frame level. In FIG. 2A, representative of the SMPTE 260M standard, a frame comprises 1125 scan lines. In FIG. 2B, on the other hand, representative of the ITU-R BT.1120 1250/50 standard, a frame comprises 1250 scan lines.

Conventional raster generators typically operate by maintaining two counters, for the horizontal and vertical image dimensions. By adjusting the speed and range of the counters, the refresh rate and the resolution can be controlled. Synchronizing events, including the horizontal and vertical synchronization and blanking, are derived by comparing the content of the counters with programmable reference values. The programmed parameters for producing the event timing of FIG. 1A, for example, would be the reference value set of {44, 192, 2112, 2156, 2200}, corresponding to the illustrated event transition times, whereas the programmed parameters for producing the event timing of FIG. 1B would be the reference value set of {64, 256, 2176, 2240, 2304}. Similarly, the reference value sets for the vertical synchronization illustrated in FIGS. 2A and 2B would be {41, 558, 603, 1121, 1125} and {45, 621, 670, 1246, 1250}, respectively. Note, however, that the use of such counters and reference values sets is feasible only if the format of the raster of each standard is substantially similar, differing only in the timing of each event. The different synchronization schemes for processing, for example, the interlaced and progressive images required by the ATSC standards for television, and the VESA standards for CRT related displays, do not lend themselves to this counter-reference timing scheme for generating the required raster for each.

### BRIEF SUMMARY OF THE INVENTION

An object of this invention is to provide a raster generation system and method that can be configured to provide raster signals corresponding to existing and future television and display standards. A further object of this invention is to provide a raster generation system and method that is freely programmable to generate all possible rasters and synchronizing patterns found in the current graphics and HDTV environment. A further object of this invention is to provide a generation system and method that is capable of generating separate as well as embedded synchronization information.

These objects and others are achieved by providing a raster generator that sequences through a list of line descriptors. The line descriptors include a line-count parameter and a line-type parameter. The line-type parameter defines the characteristics of each type of raster line, and the line-count parameter defines the number of lines of this type occurring in the sequence of lines that define the entire video or image frame. For efficient encoding, the characteristics of each type of raster line is defined in terms of a list of raster pattern types, each raster pattern type being further defined in terms of a sequence of specified durations of particular raster values. The raster generator sequences through the lists of line descriptors, raster patterns, and duration-value pairs, in a nested fashion, thereby generating the frame raster pattern as a sequence of individual raster values that occur for specified durations within each frame. In a preferred embodiment, the raster generator includes a programmable memory for containing each of the parameters that define raster.

### BRIEF DESCRIPTION OF THE DRAWINGS

The invention is explained in further detail, and by way of example, with reference to the accompanying drawings wherein:

FIGS. 1A and 1B illustrate example timing diagrams of a raster line corresponding to an active video line in accordance with prior art standards.

FIGS. 2A and 2B illustrate example frame structures corresponding to a video frame in accordance with prior art standards.

FIG. 3 illustrates an example block diagram of an encoder that provides a composite video signal for displaying an image in accordance with this invention.

FIG. 4 illustrates an example data structure for storing the parameters associated with raster generation in accordance with this invention.

FIG. 5 illustrates an example block diagram of a raster generator in accordance with this invention.

FIG. 6 illustrates an example flow diagram of a raster generator in accordance with this invention.

FIG. 7 illustrates an example partial encoding of raster generation parameters in accordance with this invention.

FIG. 8 illustrates an example partial raster generation corresponding to the example parameter encodings of FIG. 7.

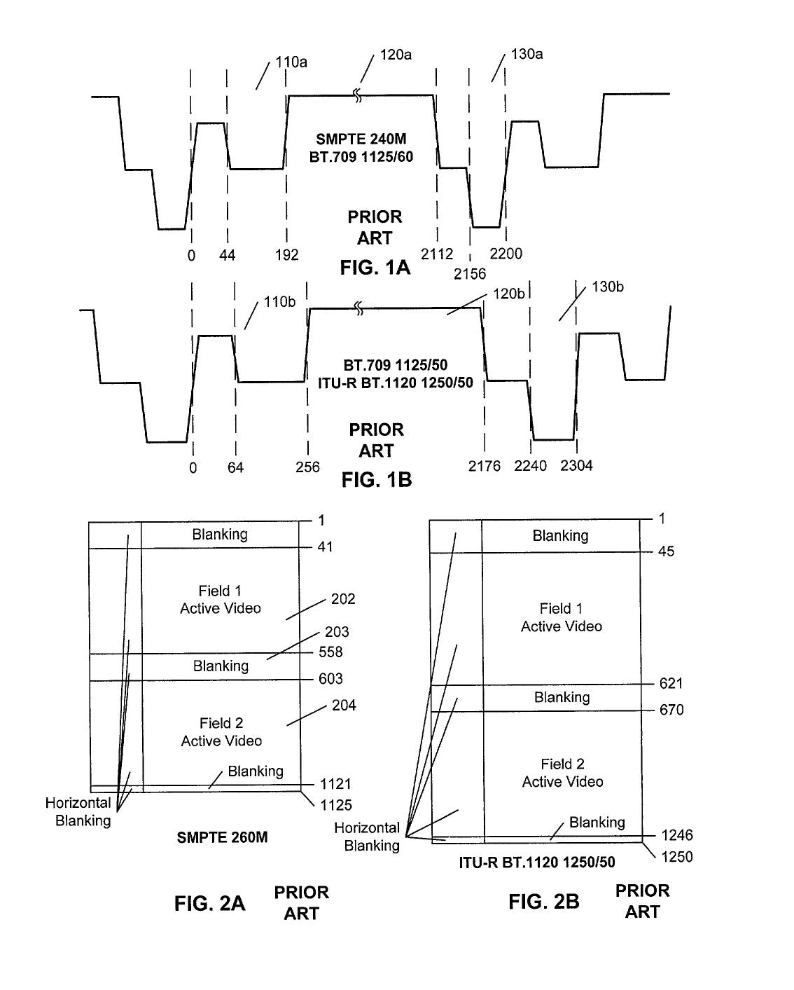

Throughout the drawings, the same reference numerals indicate similar or corresponding features or functions.

### DETAILED DESCRIPTION OF THE INVENTION

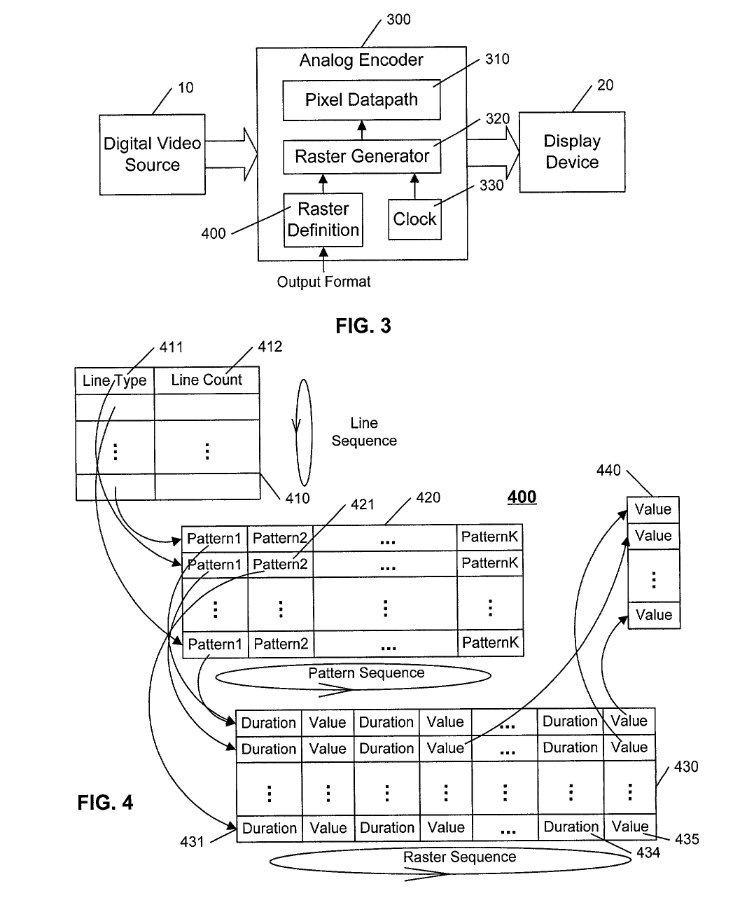

FIG. 3 illustrates an example encoder 300 that provides a composite video signal for displaying video images from a source 10 to a display 20. As illustrated, the encoder 300 receives the video images from a digital video source 10, such as a DVD reader, an MPEG decoder, a computer system, and so on, and provides analog signals in a form that is compatible with a conventional display 20, such as a television receiver, a monitor, and so on. As will be evident to one of ordinary skill in the art, the encoder 300 may be used in other applications as well. For example, the encoder 300 may be used to provide a composite video signal to a transmitter that is configured to transmit the signal to a conventional display, or to provide the composite signal to a device that is configured to store and/or process composite video signals.

The example encoder 300 includes a picture element (pixel) datapath 310, a raster generator 320, a clock 330, and a raster definition 400. The datapath 310 is configured to provide the sequence of video information items corresponding to each active (displayable) line of the image, and the raster generator 320 is configured to augment the video image with the required raster synchronization and format to allow the active lines of the image to be displayed properly. The raster generator 320 and datapath 310 may also be configured to provide ancillary information, such as teletext, or calibration signals, to be included in the composite signal that is communicated to the display 20.

In accordance with this invention, the raster generator 300 provides the required raster signaling by processing parameters contained in the raster definition 400. In a preferred embodiment, the raster definition 400 is contained in a programmable memory, although any of a number of alternative embodiments are feasible. For example, the raster definition for a variety of raster formats may be precoded in a memory area an integrated circuit, and the appropriate raster definition is selected via a format switch (not illustrated). The format switch may be externally controllable, or it may be preset during manufacturing to produce encoders of each specific format. By using a directly programmable memory, wherein each parameter of the raster can be programmed into the encoder 300, the encoder 300 can be freely programmable to accommodate the use of existing or new standards, after the manufacture of the encoder 300. Also, by allowing each parameter of the raster generation to be programmable, the responsibility of the manufacturer of the encoder 300 for directly supporting multiple raster standards is substantially eliminated, allowing design resources to be allocated to activities that are potentially more profitable.

FIG. 4 illustrates an example data structure for storing the parameters of the raster definition 400 in a preferred embodiment of this invention. This invention exploits the repetitive nature of a raster, while still allowing for detailed customization. This is effected via a list of line descriptors 410 that define each raster line within the raster. Recognizing the repetitive nature of a raster, the line descriptors in the list 410 include a line-count parameter 412 that specifies how many lines of the same type are contiguously repeated. Thus, for example, the raster description of the 517 lines of active video 202 in FIG. 2 (558 minus 41) would comprise a single entry that includes a line-count value of 517, and a definition of the raster line structure for each of these lines. A unique raster line structure can similarly be included, merely by specifying a line-count of one.

Any number of techniques may be used to define the raster line structure for each line-count in the list 410. In a preferred embodiment, recognizing that some line structures may occur at multiple non-contiguous locations in the raster, the list 410 is structured to contain a line-type indicator 411, or pointer. This line-type 411 points to a definition of the raster line structure within a set of raster line structures 420 for each unique line-type 411, thereby allowing multiple non-contiguous raster lines of the same type to be encoded in the list 410 via the use of the same value as their corresponding line-type 411.

Similarly, any number of techniques may be used to define the raster line structures 420 of each line-type 411. In a preferred embodiment, recognizing that some line structures may contain similar patterns in parts of the raster line, the structure of each line-type is defined as a sequence of raster patterns. For example, the horizontal blanking pattern of each line in the active video field 202 of FIG. 2A may be identical to the horizontal blanking pattern of each line in the vertical blanking field 203. This identical pattern in each line is preferably encoded by pointing to the same pattern of sequences within a list of sequences 430, rather than explicitly encoding the details of each pattern of sequences each time the pattern appears within a raster line structure 420 corresponding to each line-type 411.

In like manner, any number of techniques may be used to define the pattern of sequences 430 of each pattern pointed to by the entries 421 in the line structures 420. In a preferred embodiment, each pattern sequence 431 is defined by a sequence of duration-value pairs that identify a signal value 435, and the duration 434 that that signal value 435 is to be applied in the raster. The value parameter 435 may be an encoding of the actual signal value, or a pointer to a value array 440. In a preferred embodiment of this invention, the value parameter 435 includes specific bit assignments that provide control of the raster process. For example, the most significant bit (MSB) of the value parameter 435 controls a switch that determines whether a synchronizing signal is applied, or whether the actual video is applied. That is, for example, with reference to FIG. 3, the MSB of the value parameter 435 determines whether the display device 20 receives information from the pixel datapath 310 or the raster generator 320. In this example, if the MSB indicates that synchronizing data is to be provided, the remaining bits indicate the value of the synchronizing information, by pointing to entries in the value array 440. Other means of effecting control via bit values of the value parameter 435, or other parameters, will be evident to one of ordinary skill in the art. For example, the bits in value parameter 435 may also control whether the synchronization is provided as an embedded signal within the video stream, such as used in conventional broadcast television and interfaces from VCRs and video cameras, or whether the synchronization is provided as an external signal, such as used by High-Definition (HD) protocols and interfaces such as an RGB or VGA input from a computer.

By defining each pattern as a sequence of signal values for specified durations, virtually any raster pattern can be encoded at a level of detail that is defined by the resolution of the duration and value parameters. By arranging this detailed information in a hierarchical linked list, the memory requirements for the encoding of this detailed information for the entire raster is minimized.

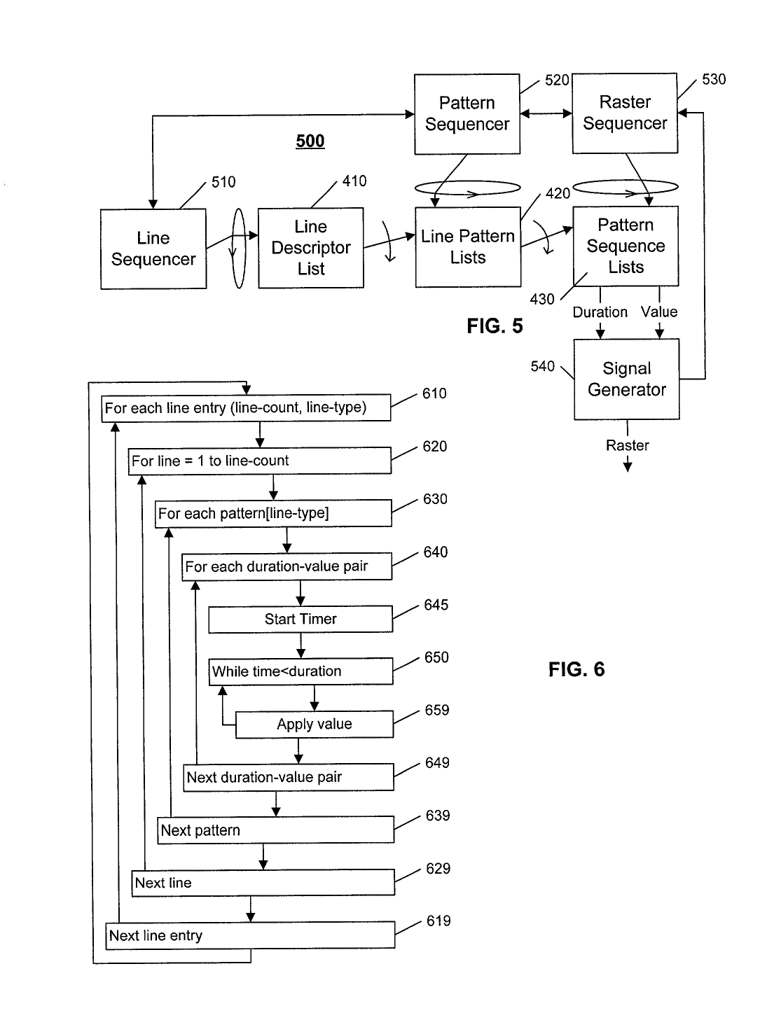

FIG. 5 illustrates an example block diagram of a raster generator 500 that is configured to use the example raster definition 400 in accordance with this invention. Note that the example structure of the definition 400 includes three levels of hierarchy (410, 420, 430), and optionally a fourth level (440). Fewer or more levels of hierarchy may also be employed, and the corresponding restructuring of the generator 500 to process different hierarchies will be evident to one of ordinary skill in the art in view of this disclosure.

The generator 500 includes a line sequencer 510 that sequences through the line descriptor list 410, a pattern sequencer 520 that sequences through the line pattern lists 420, a raster sequencer 530 that sequences through the duration-value lists 430, and a signal generator 540 that asserts the signal values corresponding to the duration and value parameters from the select pattern sequence in the list 430.

FIG. 6 illustrates an example flow diagram of the raster generator 500. For ease of understanding, the invention is presented with reference to both FIGS. 5 and 6. For convenience in referencing, the elements of FIG. 6 each begin with the numeral 6.

The line sequencer 510 sequences through the entries in the line descriptor list 410, corresponding to the loop 610-619. Feedback is provided from the pattern sequencer 520, discussed further below, to notify the line sequencer 510 when each line is completed. As discussed above, the line descriptor list 410 includes a line-count parameter (412 in FIG. 4) that corresponds to the number of repeated lines within the frame. The line sequencer 510 uses the line descriptor list 410 to select a specified line pattern, based on the line-type parameter (411 in FIG. 4), and maintains that selection for the specified line-count, as illustrated by the loop 620-629 of FIG. 6. For ease of reference, the selection of a pattern in the line pattern list 420 is indicated as coming directly from the line descriptor list 410, although typically the line-type value 411 will be read from the list 410 by a controller (not illustrated), and the controller effects the indicated selection from the list 420. This convention is also used with regard to the lists 220 and 230. At the end of the list of line descriptors 410, the line sequencer 510 repeats the processing of the list 410, via a repeat of the loop 610-619.

The pattern sequencer 520 sequences through the entries in the pattern list 420 corresponding to the selected line pattern, based on the line-type parameter 411 of the currently addressed line descriptor in the list 410, as indicated by the loop 630-639. Feedback is provided from the raster sequencer 530, discussed further below, to notify the pattern sequencer 530 when each pattern sequence is completed. Each pattern identifier within the selected line pattern effects a selection of a pattern sequence of duration-value pairs in the pattern sequence list 230.

The raster sequencer 530 sequences through the duration-value entries in the sequence list 430 corresponding to the selected pattern, based on the currently addressed pattern pointer in the list 220, as indicated by the loop 640-649. Feedback is provided from the signal generator 530, discussed further below, to notify the raster sequencer 530 when each duration is completed.

The signal generator 540 effects the generation of the specified raster value for the specified duration. As noted above the raster value may be a specified value, such as a specified voltage level, or a specified control state, such as a state that determines whether the sync value or the pixel value is asserted for the specified duration. For convenience, the term signal value is used herein to include both control states and actual values. The signal generator 540 includes a timer (not illustrated) that is initiated at the start of each duration-value assertion interval, at 650. The generator 540 asserts the specified value or state until the specified duration has elapsed, at 660-670.

Upon completion of the specified duration, the signal generator 540 notifies the raster sequencer 530, and in response, the raster sequencer 530 progresses to the next duration-value pair in the selected pattern. When the raster sequencer 530 reaches the end of the sequence of duration-value pairs comprising the selected pattern, the raster sequencer 530 notifies the pattern sequencer 520. In response, the pattern sequencer 520 progresses to the next identified pattern in the selected line.

When the pattern sequencer 520 reaches the end of the sequence of patterns that define the currently selected line, the pattern sequencer 520 notifies the line sequencer 510. The line sequencer 510 advances its line counter, and, if the specified line-count of the current entry in the line descriptor list 410 is reached, the line sequencer 510 advances to the next entry in the line descriptor list 410. When the line sequencer 510 reaches the end of the list 410, it cycles back to the start of the list 410, and the entire process is repeated.

Note that, because each level of the hierarchy is configured to notify the next higher level of the completion of its specified raster sequence, it is the lowest level detailed description that determines the timing of each event in the raster. Thus, the achievable resolution is only limited by the resolutions achievable by the lowest level description. In this manner, virtually any raster definable by this hierarchical construct of lower level details.

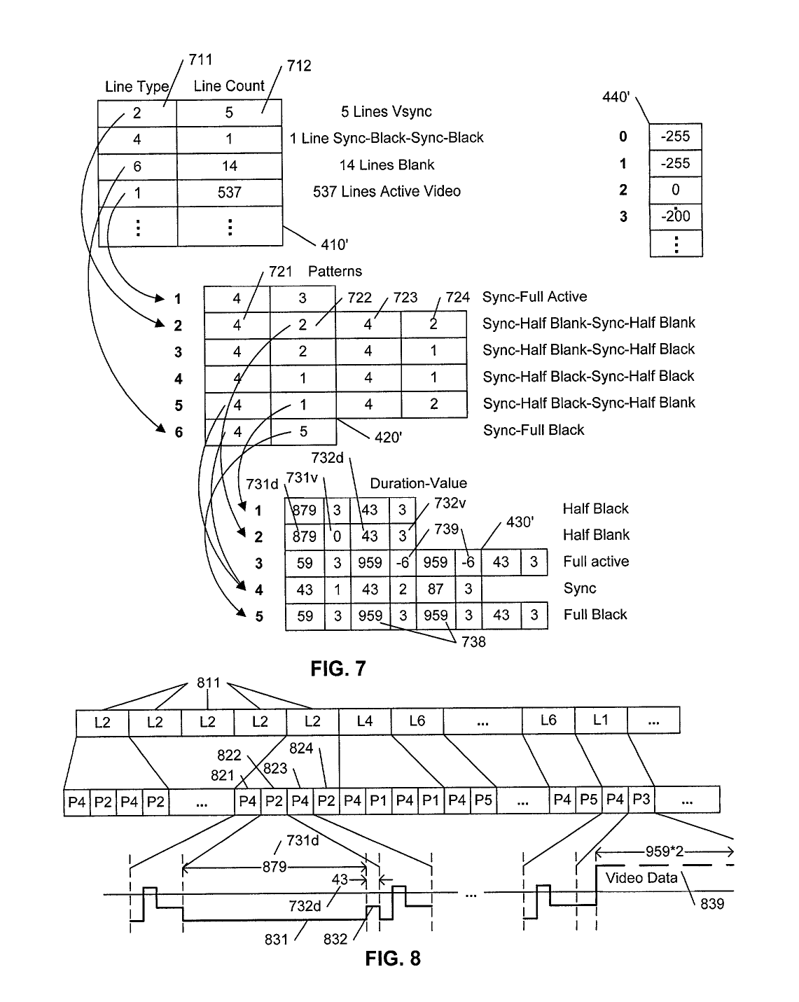

FIG. 7 illustrates an example partial encoding of raster generation parameters in accordance with this invention, and FIG. 8 illustrates an example partial raster generation corresponding to these example parameters. The parameters are contained in an example line descriptor list 410′, an example line pattern list 420′, an example duration-value list 430′, and an example value list 440′.

The line descriptor list 410′ indicates that the raster comprises five lines of line-type 2 (reference items 711, 712), one line of line-type 4, fourteen lines of line-type 6, 537 lines of line type 1, and so on. FIG. 8 illustrates the sequence of five line-type-2 lines (L2) 811, one line-type-4 (L4) 812, and so on, corresponding to the parameters in the line descriptor list 410′.

The lines of line-type-2 (711) are described in the line pattern list 420′ as comprising a sequence of pattern 4 (721)-pattern 2 (722)-pattern 4 (723)-pattern 2 (724). Each of the five lines of line-type-2 comprise this p4-p2-p4-p2 sequence, as illustrated by reference items 821-824 in FIG. 8. In like manner, each of the lines of line-type-1 comprise a sequence of p4-p3; lines of line-type-3 comprise a sequence of p4-p2-p4-p1; and so on.

Each pattern is described in the duration-value list 430′. As illustrated, for example, pattern 2 (722) comprises a signal-value-0 (731v) for a duration of 879 (731d) time units, followed by a signal-value-3 (732v) for a duration of 43 (732d) time units. In this example, the signal value parameters are pointers to the value list 440′, such that a signal-value-0 (731v) corresponds to an actual magnitude value of −255 (831), while a signal-value-3 (732v) corresponds to an actual magnitude value of −200 (832). These values 831, 832 are indicated on the timing diagram line of FIG. 8. Note that in this example encoding, a negative signal value parameter 739 in the duration-value list 430′ indicates the aforementioned pixel-value-selection state of the raster generator. For the duration of this control state, the actual video data is applied, as indicated by the reference 839 in FIG. 8.

The encoding of the parameters in the lists 430-440 includes the traditional tradeoff between resolution and available memory space. In a preferred embodiment of this invention, 10 bits are allocated to the duration parameter, wherein a unit duration is equal to one clock cycle, thereby allowing the duration to be set with a high degree of resolution. If the desired duration exceeds 10 bits, additional duration-value pairs are used, as illustrated by the dual 959 durations 738 in the list 430′ to achieve a duration of 1918 clock cycles. Similarly, 9 bits are allocated for storing values in the value list 440′, and four bits are allocated to the value pointer in the duration-value list, allowing up to sixteen different values. If, as in the example of FIG. 7, the MSB or sign bit is used to indicate a control state, only eight different values in the list 440′ can be addressed. The eight possible negative values of the four bit value pointer can be used to convey information to other components of the system, such as an indication of whether video or teletext information is to be inserted during this interval, and so on. Alternative encoding schemes will be evident to one of ordinary skill in the art in view of this disclosure.

Thus, as illustrated, any raster pattern can be defined by a sequence of duration-value pairs, any line can be defined as a sequence of raster patterns, and any raster can be defined as a sequence of lines. As with the duration-value list 430 of FIG. 4, the lists 410, 420 are allocated bits for each parameter based on an allocation of available memory. In a preferred embodiment, four bits are allocated to the line-type parameter, allowing sixteen different line types, and ten bits are allocated to the line-count parameter, allowing for a repetition of up to 1024 lines of the same type. The list 410 is structured to contain up to 16 line descriptor entries, a line-count value of zero is used to indicate the logical end of the list 410. The list 410, containing the description of the sixteen different line types, is configured to allow up to eight patterns to describe each line. Three bits are allocated for referencing each pattern, thereby allowing up to eight different patterns in the list 430. Each pattern in the list 430 may contain up to four duration-value pairs. These bit allocations are provided as an allocation that the inventor has found to be well suited for the encoding of existing and anticipated raster structures; alternative allocations may be used, depending upon available memory resources, and/or other anticipated raster formats.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the encoder 300 is preferably embodied in hardware, with a programmable memory for loading and storing the raster parameters. However, as processing speeds continue to increase, the encoder 300, or parts of the encoder 300, may be embodied in a software-based application. In like manner, a combination of hardware and software may be used. The pattern and raster sequencers 520, 530 and the signal generator 540, and their associated lists 420, 430 may be hardware devices, while the line sequencer 510 and line descriptor list 410 may be software or firmware modules. These and other system configuration and optimization features will be evident to one of ordinary skill in the art in view of this disclosure, and are included within the scope of the following claims.

We claim:

1. A raster generator comprising:
a line sequencer that is configured to sequence through a list of line descriptors,
each line descriptor of the list of line descriptors including a line-count parameter and a line-type parameter,
the line-count parameter corresponding to a number of raster lines corresponding to the line-type parameter,
the line-type parameter corresponding to a descriptor of a sequence of raster signals that form each raster line corresponding to the line-type parameter, and
a signal generator that is configured to produce the sequence of raster signals based on the descriptor of the sequence.

2. The raster generator of claim 1, further including
a programmable memory that is configured to contain the list of line descriptors.

3. The raster generator of claim 1, wherein
each descriptor of the sequence of raster signals corresponds to a set of pattern identifiers, and
the raster generator further comprises
a pattern sequencer that is further configured to sequence through the set of pattern identifiers to produce a set of pattern sequences corresponding to the descriptor of the sequence.

4. The raster generator of claim 3, further including
a programmable memory that is configured to contain each set of pattern identifiers.

5. The raster generator of claim 3, wherein
each pattern sequence of the set of pattern sequences corresponds to a set of duration-value pairs, and
the signal generator produces the sequence of raster signals by applying particular raster values for particular durations, based on the duration-value pairs.

6. The raster generator of claim 5, further including
a programmable memory that is configured to contain each set of duration-value pairs.

7. An encoder that is configured to receive a digital representation of an image and to produce therefrom a composite video signal that is suitable for display on a display device, wherein the composite video signal includes a video component and a raster component, the encoder comprising:
a datapath that is configured to transform pixel data into the video component of the composite video, and
a raster generator that is configured to provide the raster component,
the raster component comprising a plurality of raster lines,
wherein
the encoder also includes
a raster definition data set that is configured to include
a first link list that includes a plurality of line parameters,
each line parameter including a line-count parameter and a line-type parameter,
the line-count parameter corresponding to a number of raster lines of the plurality of raster lines corresponding to the line-type parameter, and
the line-type parameter including a pointer to one or more descriptors of the raster lines corresponding to the line-type parameter, and
the raster generator is configured to provide the raster component of the composite video signal by processing the descriptors of each of the raster lines, via the first link list.

8. The encoder of claim 7, wherein
the one or more descriptors of the raster lines includes
a second link list that includes pointers to one or more sets of raster sequences.

9. The encoder of claim 8, wherein
each of the one or more raster sequences includes a plurality of sequence descriptors that define discrete intervals for asserting raster values.

10. A method for generating a raster, comprising
sequencing through a list of line entries that each include a line-type and a line-count, and
applying raster signals corresponding to each line-type repeatedly, based on the corresponding line-count.

11. The method of claim 10, further including
programming the list of line entries into a memory that is accessed to effect the method.

12. The method of claim 10, wherein
applying the raster signals corresponding to each line-type further includes
sequencing through a list of raster patterns corresponding to each line-type.

13. The method of claim 12, further including
programming the list of raster patterns into a memory that is accessed to effect the method.

14. The method of claim 12, wherein
applying the raster signals corresponding to each line-type further includes
sequencing through a list of duration-value pairs corresponding to each raster pattern.

15. The method of claim 14, further including
programming the list of duration-value pairs into a memory that is accessed to effect the method.
